(19) United States
(12) Patent Application Publication
(10) Pub. No.: US 2009/0083123 A1
(43) Pub. Date: Mar. 26, 2009

(54) Systems and methods for inventory level improvement by data simulation

(76) Inventors: Haydn James Powell, Dunlap, IL (US); Paul David Force, Morton, IL (US); Konstantin Perlov, Peoria Heights, IL (US); Justin Elias Sanchez, Green Valley, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/902,817

(22) Filed: Sep. 26, 2007

(51) Int. Cl. G06Q 10/00

(52) U.S. Cl. 705/10

(57) ABSTRACT

Methods and systems for inventory management are disclosed. In one embodiment, an inventory manager may use an inventory management system to perform an inventory management process. The inventory management process includes generating inventory data points simulating a demand and a supply chain response time and providing an inventory diagram based on the simulated demand and supply chain response time. The inventory management process further includes determining a variability inventory level corresponding to a service level based on the inventory diagram and providing a proper inventory level based on the variability inventory level.

### TECHNICAL FIELD

This disclosure relates to systems and methods for inventory management. More particularly, this disclosure relates to systems and methods for optimizing inventory levels in a supply chain.

### BACKGROUND

A supply chain is a coordinated system of organizations, people, activities, information, and resources involved in moving a product or service from a supplier to a customer. For example, a supply chain may begin with the acquisition of raw materials and may include several production stages, such as a component construction stage and a product assembly stage. The supply chain further may include various transportation stages and several layers of storage facilities of various sizes and geographical locations. At the end of the supply chain, the product may be released/delivered to a customer.

The term “inventory” refers to a list of goods and materials, or those goods and materials themselves, held available in stock and/or held at various stages of the supply chain by a business. Holding excessive inventory is not cost efficient for a business. On the other hand, the business also desires to avoid being out of stock.

To optimize the balance of cost and benefit, an inventory manager needs to control inventory levels by balancing the cost of excessive inventory against the need to provide a desirable service level for the customers. The term “service level” refers to a desired probability that a customer's order can be met from stock. A service level can be expressed in a number of ways, such as a percentage of orders completely satisfied from stock, a percentage of units demanded that are delivered on time, etc.

Further, inventory managers of large business enterprises oversee extremely large supply chains involving multiple products, each with a large number of components. These inventory managers have the responsibility of determining the appropriate inventory levels in the form of components and finished products to hold at each stage of a supply chain in order to guarantee specified end-customer service levels. Given the size and complexity of these supply chains, a common problem for these inventory managers is not knowing how to quantify the tradeoff between service levels and the investment in inventory required to support those service levels.

Systems and methods have been developed to determine metrics relevant to inventory management processes. For example, U.S. Pat. No. 5,946,662 to Ettl et al. (“the '662 patent”) discloses a method for providing inventory optimization for products in a complex supply chain network for multiple internal supplier or manufacturer locations and external distributor or retailer locations. The '662 patent discloses constructing a representative supply chain network model to indicate the flow of products between internal and external locations. The disclosed system also determines inventory levels and fill rates to meet the service level requirements, calculates a total inventory cost for all products in the network, and optimizes the fill rates based on estimated gradient information of the total inventory cost.

While conventional methods, such as the one disclosed by the '662 patent, may be effective for determining inventory levels in certain situations, they do not provide an inventory level improvement process that accounts for uncertainties in a supply chain. Furthermore, conventional methods do not provide an inventory level improvement process that can take into account uncertainties of both supply chain response time and customer demand. Methods and systems consistent with the disclosed embodiments address one or more of these problems.

### SUMMARY OF THE INVENTION

Methods and systems for inventory management are disclosed. In one embodiment, an inventory manager may use an inventory management system to perform an inventory management process. The inventory management process includes generating inventory data points simulating a demand and a supply chain response time and providing an inventory diagram based on the simulated demand and supply chain response time. The inventory management process further includes determining a variability inventory level corresponding to a service level based on the inventory diagram and providing a proper inventory level based on the variability inventory level.

### BRIEF DESCRIPTION OF THE DRAWINGS

The accompanying drawings, which are incorporated in and constitute a part of this specification, illustrate exemplary embodiments and, together with the description, serve to explain these disclosed embodiments. In the drawings:

FIG. 1 is a block diagram of an exemplary inventory management architecture consistent with certain disclosed embodiments;

FIG. 2 is a block diagram of an exemplary inventory profile consistent with certain disclosed embodiments;

FIG. 3A is an exemplary data table used in calculating a base inventory level consistent with certain disclosed embodiments;

FIG. 3B is a block diagram of an exemplary supply chain response time consistent with certain disclosed embodiments;

FIG. 4 is another exemplary data table used in calculating a variability inventory level consistent with certain embodiments;

FIG. 5 is a flow chart of an exemplary inventory management process consistent with certain disclosed embodiments;

FIG. 6 is an exemplary data table used in determining a variability inventory level consistent with certain disclosed embodiments;

FIG. 7 is an exemplary scatter plot used in determining a variability inventory level consistent with certain disclosed embodiments; and

FIG. 8 is another exemplary scatter plot used in determining a variability inventory level consistent with certain disclosed embodiments.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

Methods and systems consistent with the disclosed embodiments may relate to an inventory management system for managing one or more groups of business organizations, including product manufacturers, warehouses, and dealerships. It should be noted that applications of the disclosed embodiments are not limited to any particular type of business entity.

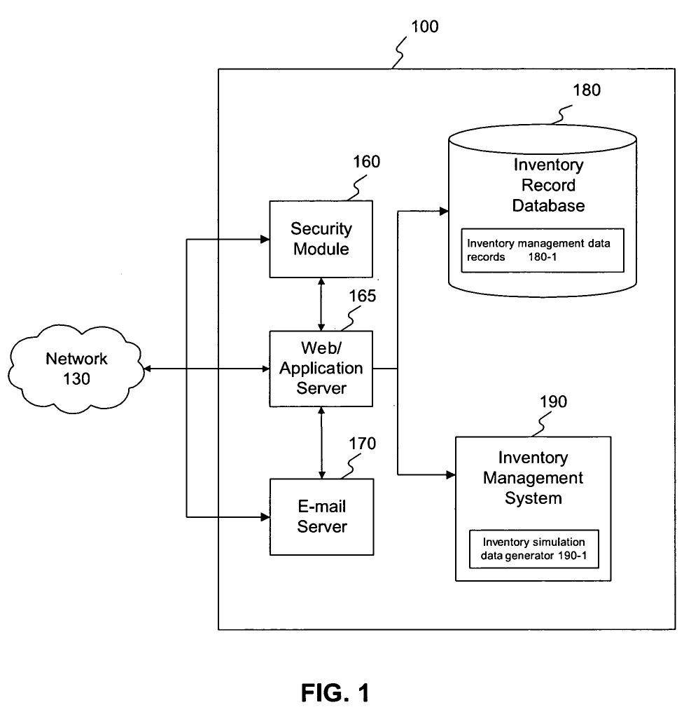

FIG. 1 is a block diagram illustrating an inventory management architecture 100 consistent with certain disclosed embodiments. As shown in FIG. 1, inventory management architecture 100 may include a security module 160, a web/application server 165, an e-mail server 170, an inventory record database 180, and an inventory management system 190. Security module 160, web/application server 165, and e-mail server 170 interface with network 130. web/application server 165 also may be connected to security module 160, e-mail server 170, inventory record database 180, and inventory management system 190. It is contemplated that an inventory management architecture 100 may include additional or fewer components than those shown in FIG. 1.

Inventory management architecture 100 may be a computer system including hardware/software that enables collaboration among users of inventory management architecture 100, such as one or more inventory managers. In one embodiment, an inventory manager may be responsible for optimizing inventory levels for one or more supply chains. The term “inventory level” refers to the total amount of merchandise or products held in a warehouse, a dealership, or across a supply chain. The term “inventory level improvement” refers to the process of determining the minimum inventory level needed by a business (e.g., a dealership) to meet its customers' demand at a desired service level. A service level may be defined as a percentage of customer orders completely satisfied from stock.

A user of inventory management architecture 100 may be any individual, software application, and/or system that uses the features of inventory management architecture 100. A user of inventory management architecture 100 may generate, maintain, update, delete, and present inventory data records and inventory data change entries. An inventory data record may include any data related to inventory management used by inventory management architecture 100.

Each component of inventory management architecture 100 may exchange data via network 130. Network 130 may be the Internet, a wireless local area network (LAN), or any other type of network. Thus, network 130 may be any type of communications system. Each user of inventory management architecture 100 may provide inquiries or respond to inquiries using network 130.

Security module 160 may be a computer system or software executed by a processor that is configured to determine the type of access each user of inventory management architecture 100 is authorized with respect to inventory record database 180 and/or inventory management system 190. For example, security module 160 may determine that a first inventory manager may be authorized to access data records in inventory record database 180 but may not be authorized to modify the records related to inventories managed by other users of inventory management architecture 100. A second inventory manager, on the other hand, may be permitted to access and modify all data records stored in inventory record database 180. Further, security module 160 may be used to assign and verify different levels of access for different users based on, for example, a user's role in inventory management architecture 100.

Web/application server 165 may include an interface that allows users to access and edit inventory record database 180 and/or inventory management system 190. Further, web/application server 165 may generate a notification, such as an e-mail, that is sent to one or more users of inventory management architecture 100. The notification may indicate that the inventory management architecture 100 has completed an operation or a record has been received. The notification may also indicate that the operation or record is available for review.

Web/application server 165 may also include additional components, such as software communication tools that permit collaboration of users of inventory management architecture 100, bulletin boards to permit users to communicate with each other, and/or search engines to provide efficient access to specific entries in inventory record database 180 or inventory management system 190. In one embodiment, web/application server 165 may be the Apache HTTP Server from the Apache Software Foundation, IBM WebSphere, or any other web/application server known in the art.

E-mail server 170 may be a computer system or software executed by a processor that is configured to provide e-mail services for users of inventory management architecture 100. The e-mail services may provide messages including current information from inventory management architecture 100. For example, when a delivery to a dealership is delayed, an inventory manager may use e-mail server 170 to send messages to other users of inventory management architecture 100.

Inventory record database 180 may be a database system and/or software executed by a processor that is configured to store data records, entries for changes made to the data records, and other information used by users of inventory management architecture 100. Inventory management architecture 100 may include one or more inventory record databases 180.

In one embodiment, inventory record database 180 may store an inventory management data record 180-1. Inventory management data record 180-1 may include inventory information tracking the acquisition, storage, transportation, sales, or consumption of certain inventory items. An inventory management data record 180-1 may include audit data and/or statistic estimates used to manage inventory. Inventory management data record 180-1 may also include information of one or more service levels. As explained earlier, a service level may be defined as a percentage of orders completely satisfied from stock. For example, an inventory management data record 180-1 may indicate that a dealership, such as a dealership A, desires to maintain a certain inventory level for machine B (e.g., 5 machine Bs) so that 95% of the customer orders can be satisfied from its stock (a service level of 0.95).

Inventory management system 190 may be a computer system or software executed by a processor that is configured to provide access to data records stored in a number of different formats, such as a word processing format, a spreadsheet format, presentation format, and the like. Inventory management system 190 may facilitate capture of inventory management data records 180-1 and changes to inventory management data records 180-1, by hosting a management process that facilitates the activities of users of inventory management architecture 100. Inventory management system 190 may also enable users of inventory management architecture 100 to define inventory management data record 180-1 and the like.

In one embodiment, for dealership A, inventory management system 190 may enable an inventory manager to adjust the inventory level of machine B. The inventory manager would desire to maintain the proper inventory level (e.g., an optimal inventory level or a minimum inventory level) while ensuring sufficient inventory arrives in time before running out of stock. Inventory management system 190 may enable the inventory manager to determine the proper inventory level based on past data reflecting the quantities ordered by dealership A, the monetary value of the ordered machines, the length of time (e.g., months) dealership A takes to deplete its inventory level to zero, and other factors.

The inventory manager may divide dealership A's inventory level into two portions: a base inventory level and a variability inventory or safety stock level. First, the inventory manager may estimate the base inventory level of machine B. The term “base inventory level” refers to the portion of inventory that is needed by dealership A to maintain its stock at the average inventory demand level, given the average supply chain response time. The term “supply chain response time” refers to the time period from the initiation of an inventory order (e.g., a submission of a customer's order) to the completion of the inventory order (e.g., when the ordered item is delivered to the customer). The term “demand” refers to the quantity of inventory items (machine Bs) in an inventory order from dealership A.

In one embodiment, if dealership A sells 5 machine Bs per week (average), and it takes 12 weeks (average) for an ordered machine B to be delivered from the factory to a customer of dealership A, the inventory manager may determine the base inventory level by multiplying the demand of 5 machine Bs per week by the supply chain response time of 12 weeks. The inventory manager may determine that, for dealership A, the base inventory level is 60 machine Bs (5×12).

After estimating the base inventory level of machine B, the inventory manager may use inventory management system 190 to determine the proper inventory level by estimating a variability inventory or safety stock level. The term “safety stock level” refers to the portion of inventory that is needed by dealership A to avoid running out of stock when it encounters variations in supply chain response time and demand. In one embodiment, inventory management system 190 may use a conventional method to calculate the safety stock level as follows:

SS=Z(SL)×\sqrt{σ²_{demand}×LT+σ²_{LT}×Demand²} (1)

In equation (1), SS represents the safety stock level; Z(SL) is the Z value for the desired service level (Z value represents the number of standard deviations of a point on a distribution that is away from the mean); σ_{demand} represents the standard deviation of demand quantities; LT represents supply chain response time (lead-time); σ_{LT} represents the standard deviation for supply chain response time; and Demand represents the demand quantity. To avoid running out of stock, a business, such as dealership A, may plan to stock at an inventory level that may be the sum of the base inventory level and the variability inventory or safety stock level.

In another embodiment, inventory management system 190 may determine a safety stock level, as defined in equation (1), based on an inventory profile. An inventory profile may be any type of analysis of business functionalities and characteristics related to the inventory of a business or a supply chain. For example, a dealership, such as dealership A, may have an inventory profile with one or more types of inventory. In another example, an inventory manager may define an inventory profile comprising many categories of inventory for a supply chain of one or more manufacturers and dealerships.

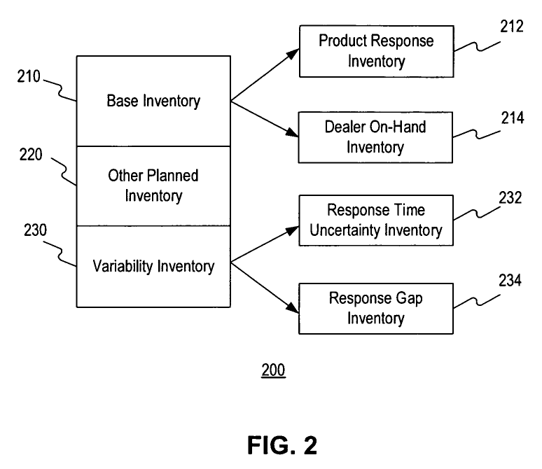

FIG. 2 shows a block diagram of an exemplary inventory profile 200 for dealership A consistent with certain disclosed embodiments. As shown in FIG. 2, in one embodiment, inventory management system 190 may define an inventory profile 200 by three functional categories: a base inventory 210, an other planned inventory 220, and a variability inventory 230. Base inventory 210 and other planned inventory 220 may be referred to as the portion of inventory held so that a dealership may stock at the average inventory demand level given the average supply chain response time. Variability inventory 230 may be referred to as the portion of inventory held by the dealership to avoid running out of stock when it encounters variations in supply chain response time and demand. In one embodiment, inventory management system 190 may define the total inventory for a business (e.g., dealership A) as a sum of its base inventory 210, other planned inventory 220, and variability inventory 230.

Base inventory 210 may reflect the inventory impact of the supply chain response time the ordering frequency and the ordering batch size of a business. The inventory impact of the supply chain response time may be determined by product response inventory 212. The inventory impact of the ordering frequency and ordering batch size may be represented by “on-hand inventory” 214.

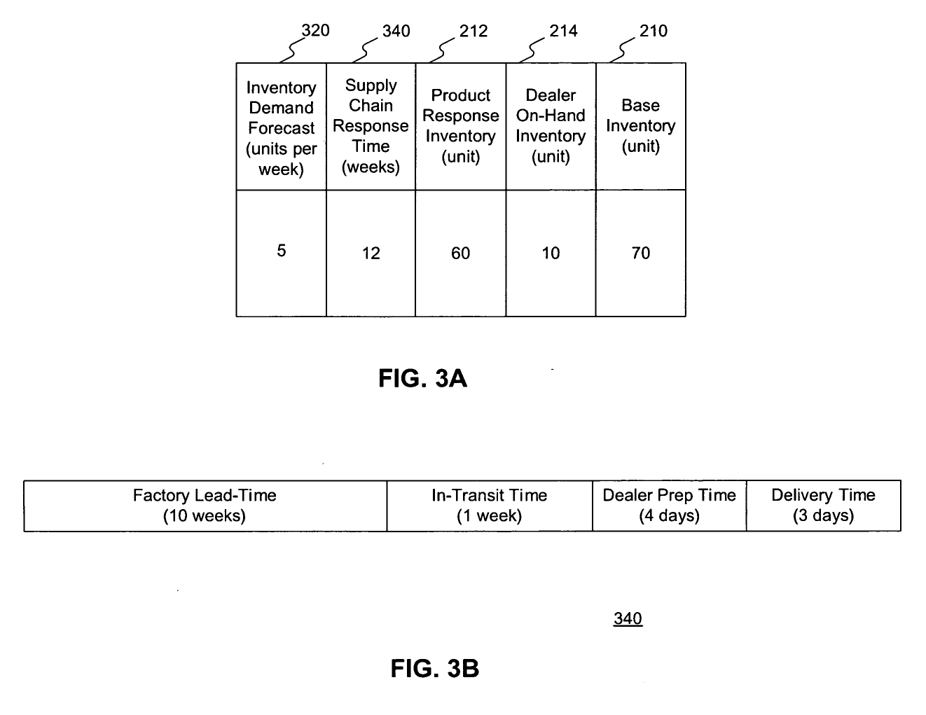

Product response inventory 212 refers to the inventory items (e.g., machine B) that are held at all stages of a supply chain (e.g., in the factory, in-transit, etc.) at any specific instant. Product response inventory 212 items are distributed throughout the whole supply chain from the point when a customer places an order to the point when the ordered item is released to the customer. Dealer on-hand inventory 214 refers to the quantity of current inventory held at a dealership or a distributor, such as dealership A (e.g., quantity of machine Bs that are always in stock). In certain embodiments, inventory management system 190 may define base inventory 210 as the sum of product response inventory 212 and dealer on-hand inventory 214. FIG. 3A shows a data table used in calculating an exemplary base inventory 210 consistent with certain disclosed embodiments.

As shown in FIGS. 2 and 3A, to determine base inventory 210, an inventory manager may first determine product response inventory 212. Product response inventory 212 is calculated based on a supply chain response time 340 (FIG. 3A). Supply chain response time 340 may be determined based on dealership A's inventory data records 180-1 (see FIG. 1) from the past. For example, the inventory manager may use the average supply chain response time for machine B from the past 5 years to forecast the supply chain response time 340 for dealership A.

Alternatively, supply chain response time 340 may be determined by summing lead-times at each stage of the supply chain. For example, as shown in FIG. 3A, for dealership A, supply chain response time 340 for machine B (the lead-time for delivering a machine B from the factory to the customer) is 12 weeks. Supply chain response time 340 for machine B may include the lead-time from each stage of the supply chain of machine B. FIG. 3B shows a block diagram of an exemplary supply chain response time 340 with lead-times from multiple stages of a supply chain consistent with certain disclosed embodiments. As shown in FIG. 3B, supply chain response time 340 may include product lead time from the factory (e.g., 10 weeks), in-transit time (e.g., 1 week for transportation), dealer preparation time (e.g., 4 days), and delivery time for the dealership to delivery an inventory item to the customer (e.g., 3 days).

Referring back to FIG. 3A, the inventory manager may also determine dealership A's inventory demand forecast quantity 320 based on dealership A's inventory data records 180-1 from the past (e.g., using average demand quantity in the past year). Alternatively, the inventory manager may estimate supply chain response time 340 and inventory demand forecast quantity 320 using statistic models and/or simulated inventory data.

Based on supply chain response time 340 and dealership A's inventory demand forecast quantity 320, inventory management system 190 may determine a product response inventory 212. In one embodiment, inventory management system 190 may define product response inventory 212 as the product of the supply chain response time 340 and the demand forecast 320. That is, product response inventory 212 (PRI) may be calculated as follows:

PRI=supply chain response time×average demand (2)

In the example of dealership A and machine B, as shown in FIG. 3A, dealership A has an average demand forecast 320 of 5 machine Bs per week (e.g., dealership A sells 5 machine Bs every week). Supply chain response time 340 for machine B is 12 weeks. Inventory management system 190 may thus determine that dealership A's product response inventory 212 is 60 machine Bs (PRI=12 weeks×5 machines/week).

Referring back to FIG. 2, to determine base inventory 210, after determining production response inventory 212, the inventory manager may next calculate dealer on-hand inventory 214. Inventory management system 190 may determine dealer on-hand inventory 214 based on an inventory order frequency (how often a dealer makes an order) and an order batch size (the quantity of inventory items ordered). The inventory order frequency and batch size may be determined based on inventory management data records 180-1. Alternatively, the inventory manager may determine the inventory order frequency and batch size by using statistic models and/or simulated inventory data.

In one embodiment, inventory management system 190 may define dealer on-hand inventory 214 as half of the inventory demand quantity for the order period. That is, dealer on-hand inventory 214 (DOI) may be calculated as follows:

DOI=average demand quantity×(OrderPeriod/2) (3)

In the example of dealership A and machine B, dealership A may place an order for machine B every month. Consistent with data shown in FIG. 3A, dealership A's inventory demand of machine B may be 20 per month (i.e., inventory demand 340 of 5 per week). As such, inventory management system 190 may determine that dealer on-hand inventory 214 corresponding to the monthly order frequency is 10 machine Bs (DOI=20×½).

In certain embodiments, inventory management system 190 may define base inventory 210 as the sum of the Supply chain response inventory 212 and the dealer on-hand inventory 214. In the example of dealership A and machine B, as shown in FIG. 3A, inventory management system 190 thus may determine that base inventory 210 for dealership A is 70 machine Bs (60 machines+10 machines).

Returning again to FIG. 2, in addition to base inventory 210, inventory profile 200 may also include other planned inventory 220. Other planned inventory 220 may account for incidental inventory orders, by a dealership or a distributor, for business reasons. In comparison to the base inventory 210, other planned inventory 220 may be a relative small quantity of products/machines. For example, other planned inventory 220 may include product/machines ordered for show room displays, for replacing an old product/machine, etc. Other planned inventory 220 may be specific to each dealership and/or each type of product/machine. An inventory manager may use inventory management system 190 to retrieve inventory management data records 180-1 from inventory record database 180 to determine a dealership's other planned inventory 220. The inventory manager may then include other planned inventory 220 as part of the dealership's inventory profile.

In the example of dealership A and machine B, the inventory manager may determine other planned inventory 220 based on dealership A's past incidental orders for business reasons. For example, if dealership A ordered 1, 3, and 2 machine Bs for marketing purposes in the past three years, respectively, inventory management system 190 may determine that other planned inventory 220 for dealership A is 2 machine Bs (average of the past three years' orders).

Further, as shown in FIG. 2, in addition to base inventory 210 and other planned inventory 220, inventory profile 200 may include variability inventory 230. Variability inventory 230 may reflect the impact of variations in the supply chain response time by including a response time uncertainty inventory 232. Response time uncertainty inventory 232 refers to a portion of inventory held by a dealership so that it would not run out of stock because of variation in the supply chain response time.

Variability inventory 230 may further reflect the impact of variations in demand during a period which the dealer may be exposed to demand uncertainty. The inventory required to mitigate the period of exposure to uncertainty defines a “Response gap inventory” 234. Response gap inventory 234 refers to the portion of inventory held by a dealership so that it can avoid running out of stock when it encounters variations in demand during a response gap time period. The term “response gap” refers to the time gap between a supply chain response time and a customer wait time, or, alternatively, the difference between a supply chain response capability and a customer's response requirement. The term “customer wait time” refers to the total elapsed time between issuance of a customer order and satisfaction of that order. A response gap of one or more days indicates a period of risk for a business (e.g., dealership A) because there is uncertainty as to demand for the inventory items during the response gap time period.

As shown in FIG. 2, variability inventory 230 may include both response time uncertainty inventory 232 and response gap inventory 234. In the following paragraphs, exemplary calculations for determining response time uncertainty inventory 232 and response gap inventory 234 are explained in detail.

First, to calculate product response inventory 232, the inventory manager needs to estimate/calculate variations in supply chain response times. Variations in supply chain response times 340 (see FIG. 3B) may include actual and estimated variations in supply chain response time throughout the whole supply chain. For example, as shown in FIG. 3B, in the above example of dealership A and machine B, product lead-time from the factory was assumed to be 10 weeks. In actual fact, there would be variations to consider when determining the product lead-time from the factory. In certain instances, the lead-time from the factory may be shorter or longer than 10 weeks. For example, an assembly line that produces machine Bs may break down, causing a longer factory lead-time for machine B. Such supply chain response time variations also exist in other stages of the supply chain (e.g., transportation stage, dealer preparation stage, etc.).

The inventory manager may estimate/forecast a future variation in supply chain response time 340 (i.e., lead-time from the factory, in-transit time, dealer preparation time, and customer delivery time) based on historical inventory data from inventory record database 180. Alternatively, inventory management system 190 may use statistic models and/or simulated inventory data to estimate the variations in supply chain response time 340.

In one embodiment, inventory management system 190 may estimate the variation in supply chain response time 340 by summing the products of weighted coefficient variations

$$( \sum {w}_{i} \times \frac{δ}{μ} )$$

of the factory lead-time, the standard deviation of the in-transit time, the standard deviation of dealership preparation time, and the standard deviation of the customer delivery time. Inventory management system 190 may assign the weight wᵢ for each coefficient variation based on the ratio of that segment's average lead-time to the total supply chain response time 340. Inventory management system 190 may further represent the variation in supply chain response time 340 using the standard deviation of supply chain response time σ_{LT}.

To determine response time uncertainty inventory 232, an inventory manager may apply the inventory profile 200 (see FIG. 2) to the safety stock level calculation as defined earlier in equation (1). Assuming there is no uncertainty in inventory demand (σ_{demand}=0) and the variation in supply chain response time 340 is σ_{LT}, inventory management system 190 may then derive from equation (1) an equation to determine response time uncertainty inventory 232. The equation may be as follows:

RUI≈Z(SL)×σ_{LT}×Demand (4)

wherein RUI represents the response time uncertainty inventory 232; Z(SL) is the Z value for the desired service level (Z value represents the number of standard deviations of a point on a normal distribution that is away from the mean); σ_{LT} represents the standard deviation for supply chain response time; and Demand represents the inventory demand quantity.

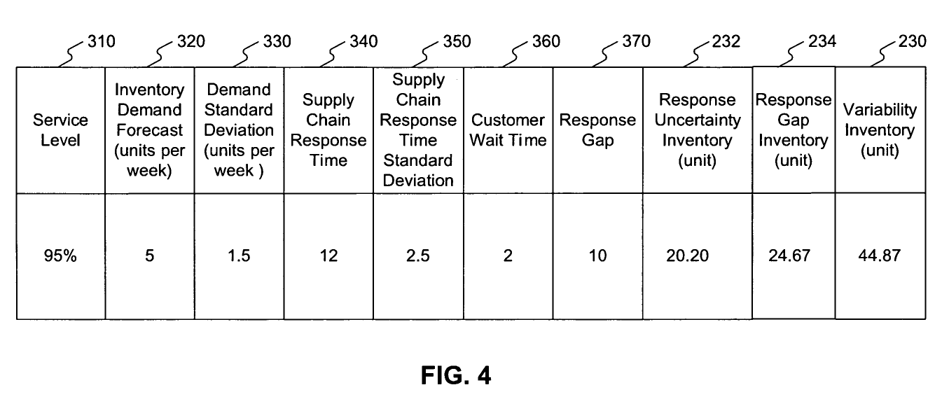

In the example of dealership A and machine B, the inventory manager may use inventory management system 190 to determine response time uncertainty inventory 232 as defined in equation (4). FIG. 4 shows an exemplary data table used in calculating a variability inventory 230 level including a response time uncertainty inventory 232 consistent with certain disclosed embodiments. As shown in FIG. 4, dealership A may require a service level 310 of 95% (SL=0.95); dealership A may have an inventory demand forecast 320 of 5 machine Bs per week (Demand=5); dealership A may have a supply chain response time 340 of 12 weeks, and the supply chain response time standard deviation 350 may be 2.5 weeks (σ_{LT}=2.5). Applying equation (4), inventory management system 190 may determine that response time uncertainty inventory 232 for dealership A is 20 machine Bs (RUI≈Z(0.95)×2.5×5=24.50).

Referring back to FIG. 2, in addition to response time uncertainty inventory 232, variability inventory 230 may further include a response gap inventory 234. FIG. 4 also shows the data used in determining the variability inventory 230 including a response gap inventory 234 consistent with certain disclosed embodiments. As explained earlier (in relation to variability inventory 230 and response gap inventory 234 as shown in FIG. 2), a response gap 370 refers to the time gap between the supply chain response time 340 and a customer wait time 360. Customer wait time 360 refers to the total elapsed time between issuance of a customer order and satisfaction of that order. The inventory manager may use inventory management system 190 to determine customer wait time 360 the based historical inventory management data records 180-1 reflecting dealership A's past customer wait time 360. Alternatively, the inventory manager may determine customer wait time 360 based on statistic models and/or simulated inventory data.

A response gap 370 of one or more days indicates a period of risk for a dealership (e.g., dealership A) because there is uncertainty as to customers' demand for the product during the response gap 370. That is, the dealership bears the risk that those machines in route to dealership A during the response gap 370 would not be sold within the expected time frame. Response gap inventory 234 thus refers to the portion of inventory held by dealership A so that dealership A can avoid running out of stock when it encounters variations in customers' demand during the timer period of response gap 370.

As shown in FIG. 4, for example, in the example of dealership A and machine B, the supply chain response time 340 is 12 weeks. Dealership A may inform each customer that machine B would be delivered 2 weeks after it is ordered by the customer. That is, dealership A has a customer wait time 360 of 2 weeks for machine B. The response gap 370 is therefore 10 weeks, which is the difference between the supply chain response time of 12 weeks and the customer wait time of 2 weeks.

Under ideal conditions, dealership A would prefer to have a 0-day response gap 370 (e.g., the supply chain response time 340 would equal to the customer wait time 360). With a 0-day response gap 370, dealership A would have no uncertainty regarding whether an ordered machine B would sell or not because dealership A can place an inventory order at the time a customer commits to a sale. Conversely, a response gap 370 of one or more days indicates a period of risk for dealership A because there is uncertainty as to whether the machine Bs in route to dealership A (in the response gap 370) would be sold or not.

In one embodiment, the inventory manager may use inventory management system 190 to estimate the uncertainties in customers' demand during the time period of response gap 370 based on the standard deviation of demand 330. The inventory manager may determine the standard deviation using historical inventory management data records 180-1 including data reflecting dealership A's past demand quantities. Alternatively, the inventory manager may determine the standard deviation of inventory demand 330 based on statistic models and/or simulated inventory data. Inventory management system 190 may refer to the standard deviation of demand as σ_{demand}.

After determining the standard deviation of demand 330 (σ_{demand}), assuming that there is no uncertainty in supply chain response time (σ_{LT}=0), the inventory manager may apply the safety stock level (i.e., variability inventory level) calculation as defined earlier in equation (1) to determine response gap inventory 234. Response gap inventory 234 may thus be calculated as follows:

RGI≈Z(SL)×\sqrt{LT}×σ_{demand} (5)

wherein RGI represents the response gap inventory 234; Z(SL) is the Z value for the desired service level (Z value represents the number of standard deviations of a point on a distribution that is away from the mean); LT represents the response gap time period; and σ_{demand} is the standard deviation of demand quantities.

Referring back to FIG. 4, in the example of dealership A and machine B, the inventory manager may use inventory management system 190 to determine response gap inventory 234 as defined in equation (5). Dealership A may require a service level 310 of 95% (SL=0.95); dealership A may have a demand forecast 320 of 5 units of machine B per week with a demand standard deviation 330 of 1.5 machines per week (σ_{demand}=1.5); and the response gap 370 may be 10 weeks (LT=10). Applying equation (5), inventory management system 190 may determine the response gap inventory 234 to be 25 machine Bs (RGI≈Z(0.95)×\sqrt{10}×1.5=9.29).

In one embodiment, inventory management system 190 may define dealership A's variability inventory 230 as the sum of response time uncertainty inventory 232 and response gap inventory 234 (see FIG. 2). In the example of dealership A and machine B, as discussed above and as shown in FIG. 4, dealership A's variability inventory 230 would therefore be 34 (24.50+9.29=33.79) machine Bs.

Further, as explained earlier in relation to FIG. 2, dealership A's total inventory may be the sum of its base inventory 210 (FIG. 3A, 70 machine Bs), other planned inventory 220 (2 machine Bs), and variability inventory 230 (FIG. 4, 34 machine Bs). In the example of dealership A and machine B, dealership A's total inventory level would therefore be 117 (i.e., 70+2+34) machine Bs.

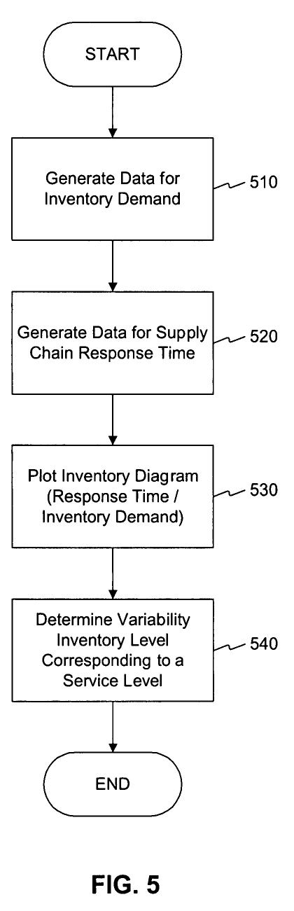

FIGS. 2-4 illustrate an embodiment of inventory management system 190, in which a safety stock level or variability inventory level, as defined in equation (1), is determined based on an inventory profile. In another embodiment, inventory management system 190 may determine a safety stock level or variability inventory level by using a simulation of demand and supply chain response time. FIGS. 5-7 illustrate an exemplary process to determine a safety stock level or variability inventory level by data simulation.

FIG. 5 shows a flow chart of the process for determining a safety stock level (i.e., a variability inventory level) by using data simulation consistent with certain disclosed embodiments. As explained earlier, the term “demand” refers to the quantity of inventory items (e.g., machine Bs) in an inventory order from dealership A. As shown in FIG. 5, the process for determining a safety stock level or variability inventory level by using data simulation may start from generating data for demand (step 510).

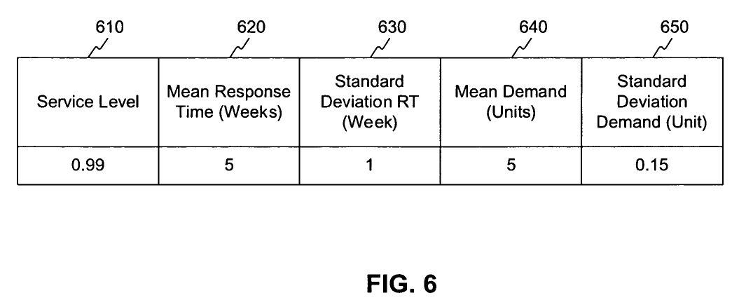

In one embodiment, a user of inventory management architecture 100, such as an inventory manager, may use inventory management system 190 and inventory simulation data generator 190-1 (see FIG. 1) to generate a set of data points reflecting the demand of a dealership. For example, a dealership, such as dealership A, may order a number of machine Cs weekly. Based on inventory management data records 180-1 reflecting past inventory order information of machine C, an inventory manager may determine that the demand for machine C has an average of 5 units per week, and about 70% of the demand quantities are within the range of 4.85-5.15 units. Further, the inventory manager may determine that the probability distribution of demand data points for machine C is a normal distribution as defined in FIG. 6.

FIG. 6 shows a data table used in the process of generating simulation data for demand (inventory demand) consistent with certain disclosed embodiments. As shown in FIG. 6, in the example of dealership A and machine C, the inventory manager may specify that the demand data falls in a normal distribution with a mean of 5 units (640) and a standard deviation of 0.15 units (650). The inventory manager may then submit the data defining the demand data distribution (e.g., a normal distribution) to inventory management system 190, and request that inventory simulation data generator 190-1 generate 5000 simulation data points.

Referring back to FIG. 5, after generating simulation data for demand, the inventory manager may further use inventory simulation data generator 190-1 (see FIG. 1) to generate a set of data points reflecting the supply chain response time of a dealership (step 520). As explained earlier, the term “supply chain response time” refers to the time period from the initiation of an inventory order (e.g., a submission of a customer's order) to the completion of the inventory order (e.g., when the ordered item is delivered to the customer). In the example of dealership A and machine C, based on inventory management data records 180-1 reflecting past inventory order information of machine C, the inventory manager may determine that the supply chain response time for machine C averages 5 weeks, and about 70% of the inventory orders completed are within the range of 4-6 weeks. Further, the inventory manager may also determine that the probability distribution for supply chain response time data points for machine C is a normal distribution as defined in FIG. 6.

FIG. 6 shows the data table that is also used in the process of generating simulation data for supply chain response time consistent with certain disclosed embodiments. As shown in FIG. 6, in the example of dealership A and machine C, the inventory manager may specify that the supply chain response time falls in a normal distribution with a mean of 5 weeks (620) and a standard deviation of 1 week (630). The inventory manager may then submit the data defining the supply chain response time data distribution to inventory management system 190, and request that inventory simulation data generator 190-1 generate 5000 simulation data points for supply chain response time.

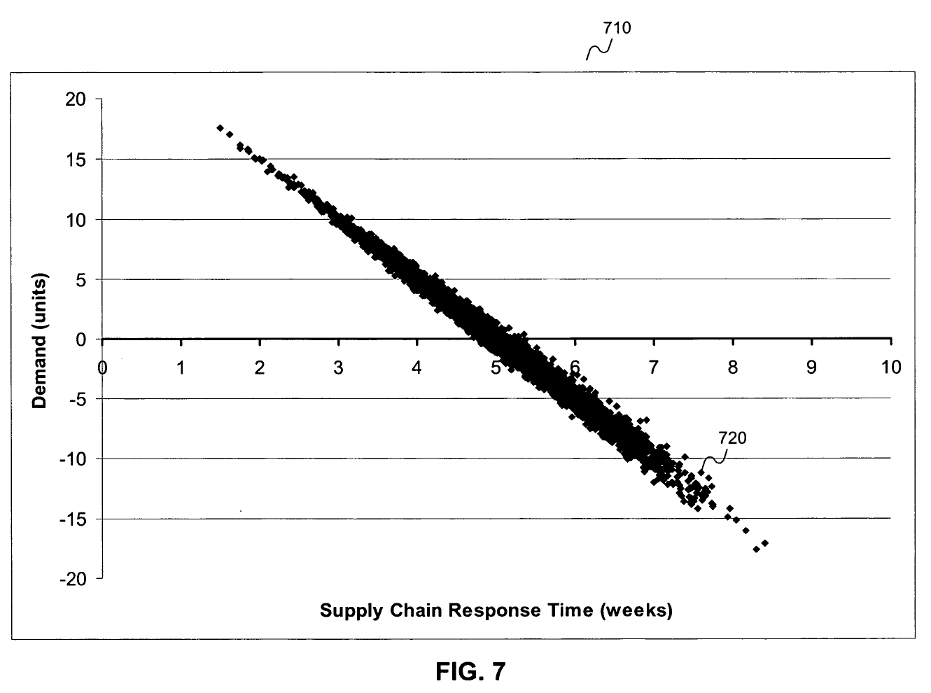

Referring again to FIG. 5, the inventory manager may then use inventory management system 190 to plot an inventory diagram using simulated data points reflecting demand and supply chain response time (step 530). In the example of dealership A and machine C, an inventory diagram 710 of demand and supply chain response time is shown in FIG. 7.

In FIG. 7, the X axis of inventory diagram 710 reflects the supply chain response time for machine C, which is plotted using the simulated data points generated in step 520 (see FIG. 5). The Y axis of the inventory diagram represents the inventory ending balance of machine C by the time an inventory order arrives at dealership A.

The inventory ending balance may refer to the quantity of inventory items available at a dealership right before a new inventory order arrives the dealership. The inventory ending balance may be estimated based on the simulated demand data. In the example of dealership A and machine C, by the time a first inventory order for machine C arrives at dealership A, machine C may be already on backorder. The quantity of the backorder for machine C (i.e., the inventory ending balance) would then be reflected in the next inventory order (a second inventory order). In one embodiment, the inventory ending balance may be estimated using the simulated demand data points generated in step 510 (see FIG. 5) by multiplying each simulated demand data point by −1.

In inventory diagram 710, about half of the data points reflect negative inventory ending balances. This indicates that about half of the time, dealership A runs out of stock by the time it receives the next inventory order for machine C. As explained earlier, the term “service level” refers to a desired probability that a customer's order can be met from stock. Inventory diagram 710 may thus reflect a service level of about 0.5 (i.e., about half of the time, a customer's order can be fulfilled from stock).

In the example of dealership A and machine C, however, dealership A may determine that it requires a service level of 0.99 for machine C (610 in FIG. 6). To achieve the predetermined service level, dealership A may add a safety stock inventory to its inventory level. Returning again to FIG. 5, the inventory manager may use inventory management system 190 to determine a safety stock level or variability inventory level that would ensure a predetermined service level using the inventory diagram (step 540). In one embodiment, the inventory manager may use inventory management system 190 to count the simulated data points to determine the safety stock level or the variability inventory level.

For example, as explained in steps 510 and 520, 5000 data points were generated for inventory diagram 710 (FIG. 7) using inventory data simulation techniques. For dealership A to ensure a service level of 0.99, only 50 (i.e., 0.01×5000) of the 5000 data points may fall under the line where inventory ending balance equals to 0 (i.e., in 50 out of 5000 instances, a customer's order cannot be fulfilled from stock). The inventory manager may therefore use inventory management system 190 to count the inventory data points as shown in FIG. 7, and determine that the 50^{th} data point 720, has an inventory ending balance of −11.57 units. The inventory manager may then determine that the safety stock level, or the variability inventory level, to achieve a service level of 0.99 is 12 (being rounded up from 11.57) machine Cs, and add the safety stock level (variability inventory level) of 12 units to dealership A's base inventory level of machine C. As explained earlier in relation to equation (1), the term “base inventory level” refers to the portion of inventory that is needed by dealership A to maintain its stock at the average demand level, given the average supply chain response time.

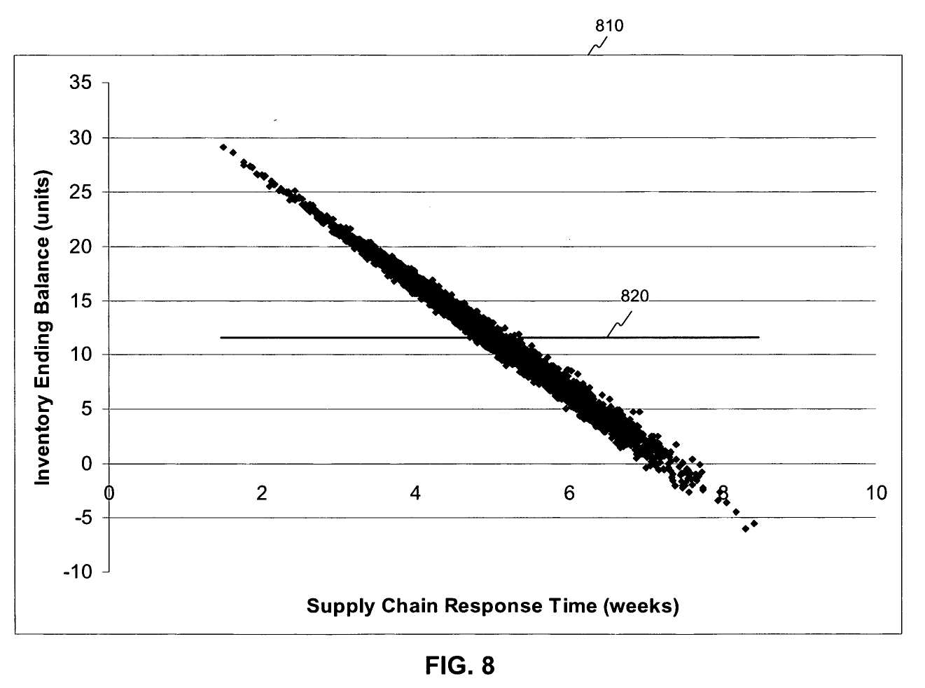

FIG. 8 shows an updated inventory diagram 810 with adjusted inventory level including a safety stock consistent with certain disclosed embodiments. As discussed above, in the example of dealership A and machine C, the inventory manager may determine that to achieve a service level of 0.99, a variability inventory level (or, a safety stock level) 820 of 12 units of machine Cs would need to be added to dealership A's base stock level. FIG. 8 shows an adjusted inventory diagram 810. As shown in FIG. 8, in the simulation described in FIGS. 5-7, once variability inventory level 820 of 12 units is added to dealership A's inventory level, 99% (0.99) of all instances of inventory ending balance is over zero. That is, for 99% of the time, dealership A does not run out of stock for machine C before the next inventory order arrives. As such, dealership A achieves a service level of 0.99.

### INDUSTRIAL APPLICABILITY

Inventory management methods and systems consistent with the disclosed embodiments may be used to support supply chain management decisions. For example, inventory management system 190 may be used to determine the effect of changing any stage in a supply chain. In one embodiment, inventory management system 190 may be used to determine the effect of adding a distribution center by calculating the supply chain response time for various segments in the supply chain. In another embodiment, inventory management system 190 may be used to determine the effect of different transportation arrangements by estimating the in-transit time.

The disclosed embodiments may enable an inventory manager to determine the inventory effect that may be caused by future changes in customers' demands. In one embodiment, inventory management system 190 may determine the response gap inventory based on uncertainties in demand forecasts. For example, demand for a certain product may be affected by seasonality, weather, and/or other marketing factors. Inventory management system 190 may estimate the uncertainty in the demand forecasts, and determine the corresponding response gap inventory. A business enterprise may therefore plan for the forecasted uncertainties by taking into consideration the response gap inventory when making inventory decisions.

The disclosed embodiments may also enable an inventory manager to optimize the decision with respect to the inventory level and the service level of a supply chain. The inventory manager may determine the inventory effect from proposed changes in service level requirements. For example, when a business is considering to change a service level requirement for a product, the inventory manager may use inventory management system 190 to determine the potential effect on its inventory levels. In one embodiment, inventory management system 190 may be used to determine the change in variability inventory levels caused by a proposed service level change.

Furthermore, from the perspective of a dealership, an auction house, or a distributor, the disclosed embodiments may enable an inventory manager to decide the inventory effect for various order frequencies. For example, the inventory manager may use inventory management system 190 to determine the dealer on-hand inventory level. The dealer on-hand inventory level is determined by the order frequency and order batch size. The inventory manager thus may adjust a dealership's order frequency and/or order batch size to achieve its targeted dealer on-hand inventory level.

It will be apparent to those skilled in the art that various modifications and variations can be made in the disclosed embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. An inventory management system, comprising:
a memory that stores program code; and
a processor that executes the program code to perform an inventory management process, the inventory management process comprising:
generating inventory data points simulating a demand and a supply chain response time;
providing an inventory diagram based on the simulated demand and supply chain response time;
determining a variability inventory level corresponding to a service level based on the inventory diagram; and
providing an inventory level based on the variability inventory level.

2. The system of claim 1, wherein the inventory management process further comprises:
updating the inventory diagram based on the determined variability inventory level.

3. The system of claim 1, wherein the inventory management process further comprises:
determining the service level; and
determining the variability inventory level corresponding to the service level.

4. The system of claim 1, wherein the inventory management process further comprises:
generating the inventory data points for the demand based on a first normal distribution.

5. The system of claim 4, wherein the inventory management process further comprises:
determining a first mean and a first standard deviation of the first normal distribution.

6. The system of claim 5, wherein the inventory management process further comprises:
generating the inventory data points for the supply chain response time based on a second normal distribution.

7. The system of claim 6, wherein the inventory management process further comprises:
determining a second mean and a second standard deviation of the second normal distribution.

8. The system of claim 7, wherein the inventory management process further comprises:
determining the number of data points for the demand and for the response time.

9. The system of claim 1, wherein the inventory management process further comprises:
determining the variability inventory level based on the service level, the simulated demand, and the simulated supply chain response time.

10. A method for inventory management, comprising:
performing an inventory management process through an interaction of users of an inventory management architecture, the inventory management process including:
generating inventory data points simulating a demand and a supply chain response time;
providing an inventory diagram based on the simulated demand and supply chain response time;
determining a variability inventory level corresponding to a service level based on the inventory diagram; and
providing an inventory level based on the variability inventory level.

11. The method of claim 10, wherein the inventory management process further comprises:
updating the inventory diagram based on the determined variability inventory level.

12. The method of claim 10, wherein the inventory management process further comprises:
determining the service level; and
determining the variability inventory level corresponding to the service level.

13. The method of claim 10, wherein the inventory management process further comprises:
generating the inventory data points for the demand based on a first normal distribution.

14. The method of claim 13, wherein the inventory management process further comprises:
determining a first mean and a first standard deviation of the first normal distribution.

15. The method of claim 14, wherein the inventory management process further comprises:
generating the inventory data points for the supply chain response time based on a second normal distribution.

16. The method of claim 15, wherein the inventory management process further comprises:
determining a second mean and a second standard deviation of the second normal distribution.

17. The method of claim 16, wherein the inventory management process further comprises:
determining the number of data points for the demand and for the response time.

18. The method of claim 10, wherein the inventory management process further comprises:
determining the variability inventory level based on the service level, the simulated demand, and the simulated supply chain response time.

19. A method for inventory management, comprising:
generating inventory data points simulating a demand and a supply chain response time;
providing an inventory diagram based on the simulated demand and supply chain response time;
determining a variability inventory level based on a service level, the simulated demand, and the simulated supply chain response time; and
providing an inventory level based on the variability inventory level.

20. The method of claim 19, further comprising:
determining a first data distribution for simulating the demand; and
determining a second data distribution for simulating the supply chain response time.
